(19) United States
(12) Patent Application Publication
(10) Pub. No.: US 2023/0325794 A1
(43) Pub. Date: Oct. 12, 2023

(54) Method, Apparatus And Computer Readable Storage To Effectuate An Instantaneous Monetary Transfer

(71) Applicant: AMERICAN EXPRESS KABBAGE INC., Atlanta, GA (US)

(72) Inventor: Rob Frohwein, Atlanta, GA (US)

(21) Appl. No.: 18/200,549

(22) Filed: May 22, 2023

Related U.S. Application Data
(63) Continuation of application No. 13/859,841, filed on Apr. 10, 2013.
(60) Provisional application No. 61/622,490, filed on Apr. 10, 2012.

(51) Int. Cl. G06Q 20/10; G06Q 20/02

(52) U.S. Cl. CPC G06Q 20/10; G06Q 20/02

(57) ABSTRACT

A method, apparatus, and computer readable storage to enable fast transfers of funds from a sender to a receiver even though they have bank accounts at different banks. A proxy is used that has an account at the receiver’s bank so that the proxy can request an intrabank transfer to the receiver which would typically be quicker than an interbank transfer. An intermediary is a party that organizes a set of transfers related to the transaction. The proxy can be paid a payment for serving as the proxy by the intermediary, the intermediary also receiving a transfer of funds from the sender.

### CROSS REFERENCE TO RELATED APPLICATIONS

This application claims benefit to provisional application 61/622,490, which is incorporated by reference herein in its entirety and a non-provisional application 13/859,841, which is incorporated by reference herein in its entirety.

### BACKGROUND OF THE INVENTION

### Field of the Invention

The present inventive concept relates to a system, method, and computer readable storage that provides a way to effectuate a quick transfer of funds from a sender’s bank account to a receiver’s bank account at a different bank than the sender’s bank.

### DESCRIPTION OF THE RELATED ART

Currently a person can send money from his or her bank account to another person’s bank account, which can take the form of a wire transfer or other type of transfer processed by the bank. A person can make such a transfer request online. One disadvantage of making such a request is that if the request is made to transfer funds outside of the current bank to another bank, then there may be delays in the processing of such transfer before the funds are received by the receiver (since multiple banks are allowed).

What is needed is faster way that transfers made outside of a sender’s bank (or other financial institution) can be effectuated.

### SUMMARY OF THE INVENTION

It is an aspect of the present general inventive concept to provide a way to enable fast transfers of funds.

The above aspects can be obtained by a method that includes (a) receiving an electronic request on a computer communications network from a sender to transfer funds from a sender’s bank account at a first financial institution to a receiver’s bank account at a second financial institution, the second financial institution being different than the first financial institution; and (b) initiating, using an electronic server connected to the computer communications network, an electronic transfer of funds from an intermediary’s bank account to a proxy’s bank account, wherein (c) the proxy’s bank account funds a transfer to the receiver’s bank account, (d) the sender’s bank account funds a transfer to the intermediary’s bank account or second intermediary bank account.

The above aspects can also be obtained by an apparatus that includes (a) a network connection configured to communication across a computer communications network; and (b) an electronic server connected to the network connection, the server configured to a) receive an electronic request on the computer communications network from a sender to transfer funds from a sender’s bank account at a first financial institution to a receiver’s bank account at a second financial institution, the second financial institution being different than the first financial institution; and b) initiate an electronic transfer using the computer communications network of funds from an intermediary’s bank account to a proxy’s bank account, (c) wherein the proxy’s bank account funds a transfer to the receiver’s bank account, and the sender’s bank account funds a transfer to the intermediary’s bank account or second intermediary bank account. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating some participants on a computer communications network, according to an embodiment;

FIG. 2 is a flowchart illustrating an exemplary method of effectuating an instant transfer of funds, according to an embodiment;

FIG. 3 is a flowchart illustrating an exemplary method of determining whether a suitable proxy exists, according to an embodiment;

FIG. 4A is a drawing illustrating an example transfer request window, according to an embodiment;

FIG. 4B is a drawing illustrating an example proxy transfer request window, according to an embodiment;

FIG. 5 is a drawing illustrating a communication sent to a receiver indicating the transfer of funds to the receiver, according to an embodiment; and FIG. 6 is a block diagram illustrating components needed to implement a digital computer that can be used to implement the methods described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a financial money transfer system which can transfer funds from a sending party (sender) to a receiving party (receiver) immediately (or very quickly). Currently, if a person has a checking (or other type of bank account) at a particular bank and wishes to send money to another person (a receiver) electronically, the outcome may depend on whether or not the recipient has a bank account at the particular bank. Some banks permit instantaneous (or near-instantaneous) transfers from an account holder at the bank to a receiver who is also an account holder at the bank (an “intrabank transfer”). If both parties (the sender and the receiver) have accounts at the particular bank, then the transfer (assuming the bank infrastructure is set up in this manner) can be easily by the sender requesting the transfer using the bank’s online servicing system (e.g., web site). The receiver can typically receive the funds in the receivers own account immediately or very quickly (e.g., the same or next business day).

If the sender and the receiver do not have accounts at the same bank (an interbank transfer), then a transfer may not be that easy. In some cases, a bank may not support online interbank transfer requests, and the sender may be required to come into the bank in person to make the interbank transfer request. Regardless of whether the bank permits online interbank transfer requests, typically such a transfer would take more time than an intrabank transfer. This is because the two different banks (the sender’s bank and the receiver’s bank) have to exchange information, verify the funds exist in the sender’s account, transfer the money between banks, etc. Thus, an interbank transfer can take a few days or more.

Embodiments of the present inventive concept can enable an interbank transfer to be made more quickly. A proxy (a person who has an account at the receiver’s bank) can be used to transfer the funds to the receiver using an intrabank transfer, and then an interbank transfer can be requested to transfer money to the proxy to reimburse the proxy. The proxy would have typically previously agreed to such an arrangement and may receive a payment for their service (which may also entail the proxy waiting for the intrabank transfer to be completed so the proxy would be reimbursed).

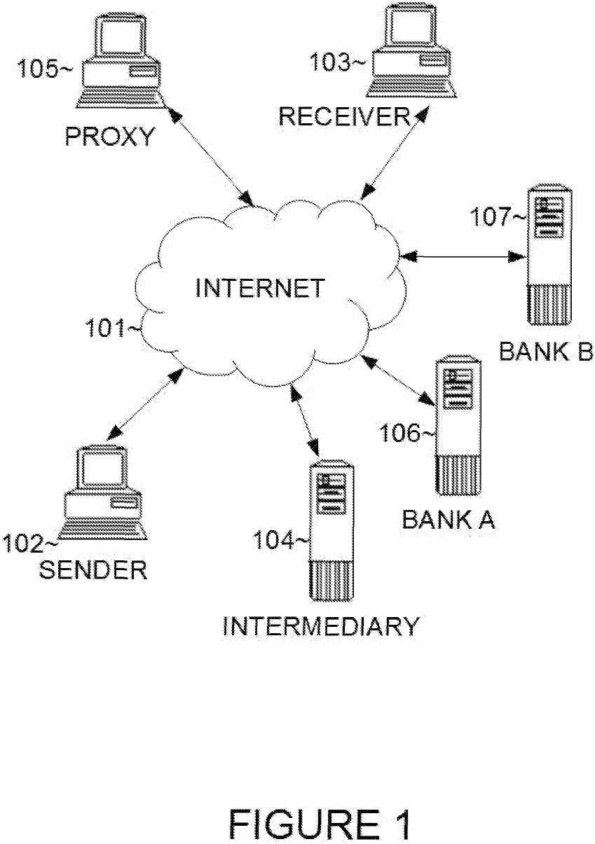

FIG. 1 is a block diagram illustrating some participants on a computer communications network, according to an embodiment.

A computer communications network such as the internet 101 is used to enable communications among all of the different participants. Sender 102 has an account at bank A 106 (shown as a server because the server would handle online transfer requests for bank A). Receiver 103 has an account at bank B 107 (shown as a server because the server would handle online transfer requests for bank B). Receiver 103 does not have an account at bank A 106 and sender 102 does not have an account at bank B 107. An intermediary 104 is a server programmed to enable a fast transfer of money from the sender 102 to the receiver 103 in accordance with the methods described herein. A proxy 105 has an account at bank B 107 and is selected by the intermediary 104 in order to effectuate the fast transfer of money.

Regarding the nomenclature used herein, payments/transfers to a party are equivalent to a payment/transfer to a bank account associated with that party. For example, as used herein, a transfer/payment from/to the receiver is equivalent to a transfer/payment from/to the receiver’s bank account. Similarly, a transfer/payment from/to the intermediary is the equivalent to a transfer/payment from/to the intermediary’s bank account. A transfer/payment from the proxy is equivalent to a transfer/payment from/to the proxy’s bank account. While a single account may be used herein for simplicity, a party may utilize multiple accounts (for example the intermediary may make a transfer to the proxy using one account and a second transfer to the proxy using another account). Payments can also be made using different methods of payment. For example, the sender’s bank account can be used to make a transfer to the intermediary, but additional fees required from the sender (e.g., additional banking fees that may be incurred) can be charged to the sender’s credit card (or can be transferred from the sender’s bank account to the intermediary in a subsequent transfer).

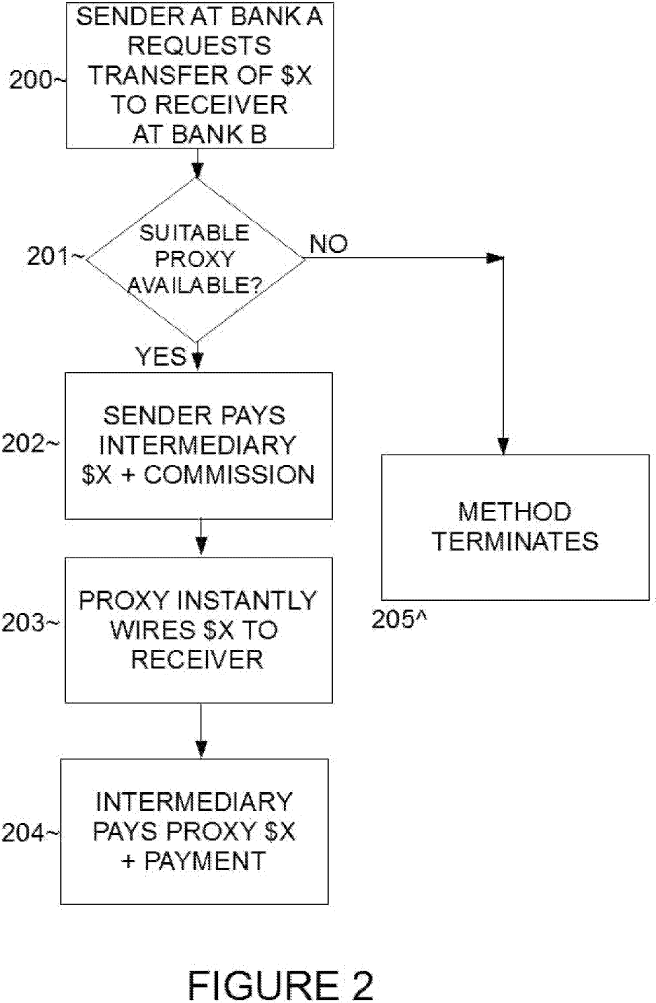

The intermediary can be the party who arranges and initiates the entire set of transactions (including those in FIG. 2) in order to effectuate the fast transfer from the sender to the receiver. The initiation of a transaction means making any request to a computer communications network which starts the process of completing that transaction. An initiating party may also complete the transaction itself or other parties the initiating party is communicating with may actually complete the transaction. For example, a transfer of funds from one party to the next can be initiated by a party who sends a complete request to a bank who actually ends up completing the transfer of funds.

The fast transfer would be effectuated as follows. The sender 102 would log into a web site hosted by the intermediary 104 and request that a transfer of $X (X dollars) plus any required banking fees needed for the transfers plus a commission the sender pays for the privilege of making the fast transfer. The sender 102 would request a transfer of funds from the sender’s 102 bank account at bank A 106 to the intermediary’s 104 bank account (this may be an intrabank or an interbank transfer). The intermediary 104 would locate proxy 105 who has a bank account at bank B 107 and agrees (or has agreed) to serve in the capacity as a proxy in this transaction. The proxy 105 would have $X in his/her account at bank B and requests an intrabank transfer of $X from the proxy’s account at bank B to the receiver’s 103 account at bank B 107. The intermediary 104 would initiate a transfer from a bank account associated with the intermediary 104 (at any bank where the intermediary 104 has an account) to the proxy’s 105 account at bank B. This latter transfer may be instantaneous (if the transfer is intrabank) or may take a period of time such as a number of days (if the transfer is interbank). The amount transferred from the intermediary 104 to the proxy 105 would be $X (plus any banking fees the proxy had to pay) plus a payment to the proxy 107 in compensation for acting as the proxy. The payment would typically be less than the commission so that the difference between the commission and the payment is profit that would be kept by the intermediary as compensation for organizing the entire transaction.

Thus, at the end of the transaction, the sender 102 paid $X (plus any required banking fees plus a commission) in order to initiate an intrabank transfer from the proxy 105 to the receiver 103. The proxy 105 would be reimbursed by the intermediary 104 for all fees the proxy 105 had to pay and the proxy 105 would also receive an additional payment (for being the proxy) from the intermediary. The intermediary would make a profit equaling the difference in commission the sender 102 paid and the payment paid to the proxy 105. Thus, in this system all parties benefit (the proxy and the intermediary both make money) while the sender gets the benefit of having his or her transfer to the receiver be converted from an interbank transfer to an intrabank transfer (to which the sender pays a commission for the benefit). The sender may be able to effectuate a transfer to the receiver more cheaply by requesting the transfer directly through the sender’s bank but it may take a prolonged period of time and thus the sender agrees to pay the commission in order to expedite the transfer in the manner described herein. The sender would typically also be responsible for paying all banking fees which would include any transfer fees for all three transfers (the sender to intermediary; the intermediary to proxy; and the proxy to receiver).

FIG. 2 is a flowchart illustrating an exemplary method of effectuating an instant transfer of funds, according to an embodiment.

The method can begin with operation 200, wherein the sender (who has a bank account at bank A but not bank B) requests from the intermediary a transfer of $X to the receiver who has a bank account at bank B (but not bank A). The sender would have previously logged in (or registered) with the intermediary wherein the sender would have provided the intermediary personal information such as the sender’s name, address bank account numbers (and other information), etc. The sender would also have to provide the receiver’s bank account information, amount to transfer, and any other relevant information.

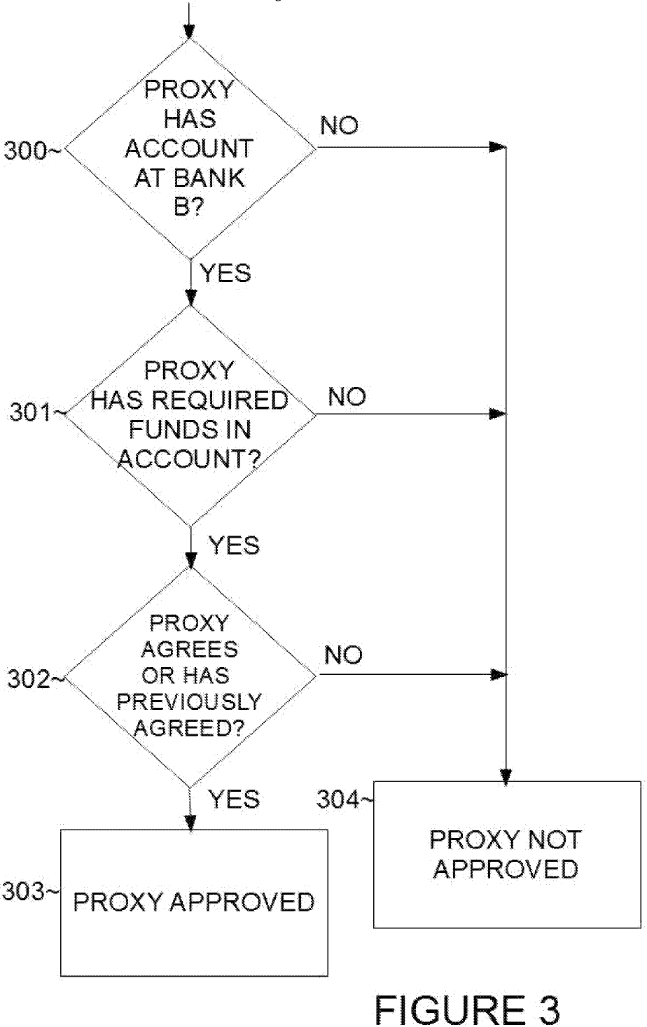

From operation 200, the method proceeds to operation 201, wherein the intermediary determines if it can locate a suitable proxy. If for some reason the request is not approved (e.g., the intermediary cannot locate a proxy at bank B) then the sender would be informed (via web page, email message, etc.) that the request is denied. A suitable proxy would be a proxy that has a bank account at bank B with $X (plus whatever banking fees are required for the proxy to make the transfer to the receiver). If it is determined that a suitable proxy is found (and the overall transaction is approved), then the sender is notified as such and the method continues to operation 202. See FIG. 3 for more detail on finding and approving a suitable proxy. If a suitable proxy cannot be found, or for some other reason the request cannot be approved, then the method proceeds to operation 205 wherein the method terminates as the transfer requested in operation 200 cannot be carried out.

From operation 201, the method proceeds to operation 202, wherein the sender pays the intermediary $X plus a commission (and possibly any banking fees that the entire transaction may require). The payment (also referred to as transfer) can be in the form of a wire transfer or bank transfer (interbank or intrabank) to a bank account associated with the intermediary. The payment/transfer can alternatively be made by the receiver to the intermediary via a credit card, PAYPAL, or any other payment mechanism. The intermediary would receive an electronic confirmation of the transfer from the sender to the intermediary so even if the transfer may take a period of time, the intermediary knows that it will eventually receive the payment from the sender. If the intermediary does not receive payment from the sender (or some type of confirmation that the payment was initiated by the sender) then the method would terminate and would not continue.

From operation 202, the method proceeds to operation 203, wherein the proxy initiates an intrabank transfer of $X to the receiver. Typically this can be done online at a web site hosted by bank B. The transfer can be initiated manually (by a human acting as the proxy) or automatically (by automatically logging in to an account of the proxy and automatically initiating the necessary transactions). For example, the intermediary could know the proxy’s banking and login information (this information could have been shared by the proxy to the intermediary when the proxy registered with the system) so that the intermediary (which can be a server running an application) can automatically log into bank B’s web site and automatically request the transfer of $X to the receiver’s account at bank B.

From operation 203, the method proceeds to operation 204, wherein the intermediary initiates a transfer to the proxy of the $X plus a payment (the payment being a fee to the proxy for participating in the transaction which the proxy can keep). The transfer from the intermediary to the proxy may be made via interbank transfer or intrabank transfer (depending on which bank account the intermediary is paying out of) or any other payment/transfer mechanism (e.g., PAYPAL, check, etc.) The intermediary’s bank account used to pay in operation 204 can be the same bank account as the intermediary’s bank account used to receive in operation 202, or the intermediary can maintain two separate accounts (e.g., one bank account for receiving in operation 202 and a different bank account for paying in operation 204).

The payment to the proxy would typically be less than the commission paid by the sender in operation 202. Thus, the difference between the commission and the payment would be the profit that the intermediary makes from the entire transaction.

Note that there are three transfers of funds (operations 202,203,204) but only operation 203 (the payment/transfer to the receiver) needs to be an intrabank transfer (or a type of transfer that is quick) so that the receiver receives the payment quickly. The other transfers/payments (operations 202,204) can be processed more slowly. Operations 201 to 204 can all be processed automatically, using computer servers that can log in to bank (and other) web sites and request the transactions that are needed.

Operations 202 to 204 can be performed in any order. The methods described herein can be applied to accounts not just at banks but at any financial institution (e.g., brokerage houses, PAYPAL accounts, credit card accounts, etc.) It is also noted that financial institutions can be located around the world, so that transfers to a receiver located in foreign country with an account in a foreign financial institution can be quickly completed (since a proxy may be found at that foreign financial institution).

The intermediary can have a plurality of proxies it can use to facilitate the transaction. Proxies can be accounts set up by the intermediary and owned by the intermediary for this purpose (in this embodiment, payments to the proxies for participating in the method may not be necessary). Or, proxies can be separate entities (such as private people) who have agreed to sign up with the intermediary in order to help facilitate this type of transactions (and earn the respective payment each time). Thus, the intermediary would have a database of potential proxies it can examine to find a suitable one to use.

Proxies can also be “crowd-sourced.” For example, people with accounts at various banking institutions can register with the intermediary to be a proxy. The registration process can entail the proxy signing up on a web site hosted by the intermediary and providing personal information (e.g., name, address, username/password, banking information, bank name routing number, current balance, etc.) When a particular proxy is needed with certain characteristics (e.g., they must have an account at a particular bank with at least a certain amount of funds), a suitable proxy can be identified from registered proxies. Proxies may voluntarily register because of the potential of earning the payments for being part of the method.

FIG. 3 is a flowchart illustrating an exemplary method of determining whether a suitable proxy exists, according to an embodiment.

The method can evaluate all registered proxies and find one that meets the particular criteria needed for the current transaction. In operation 300, a potential proxy must have an account at bank B (the bank the receiver is requested funds at), and if not then the potential proxy is not approved. There may be one or more potential proxies that have an account at bank B, and only one would ultimately be used for the task.

In operation 301, the potential proxy must have the required funds in the potential proxy’s account at bank B. This can be done by automatically (or manually) logging into the potential proxy’s bank web site and checking to see the balance. The required funds would be at least the amount the sender wants to transfer plus whatever other banking fees may be deducted from the potential proxy’s account. The potential proxy may also need to keep a minimum balance in this account and so this minimum amount should be considered, so that the potential proxy would be approved if the required funds are greater than the minimum balance. If the potential proxy does not have these funds in his or her account at bank B at the time, then the potential proxy is not approved.

In operation 302, the potential proxy must agree or have previously agreed to conduct the transaction. All registered proxies may be required to sign an agreement giving the intermediary authority to automatically log into their bank accounts and request any transfers (of the kind in operation 203) assuming there is enough funds in the respective bank account. Alternatively, potential proxies can be informed of the potential to receive a payment for making a transfer and a potential proxy would have to respond in the affirmative in order to complete the transaction.

If the potential proxy is approved, then the method proceeds to operation 303 wherein the method would continue to operation 202. It is noted that there may be other conditions used to screen potential proxies in addition to the ones listed in FIG. 3.

If in operation 304 the potential proxy is not approved, then other potential proxies can be screened until a suitable one is found. If no suitable proxy can be found, then the intermediary may not be able to effectuate the transaction (and the method would not proceed from operation 201 to 202).

Note that operations 300 to 302 could be performed for all potential proxies known to the intermediary. The intermediary may of course have a database (e.g., SQL based) wherein the pool of potential proxies can be immediately culled to ones that have all of the required characteristics. Some characteristics may require additional steps be taken (such as operation 301) which may require logging in to a potential proxy’s bank account in order to verify their funds. If more than one potential proxy meets the requirements, then in the embodiment where all proxies agree they can be used then one can be selected at random (or other manner). If more than one proxy meets the requirements, then in the embodiment where proxies must give permission before being used to effectuate the transaction, the pool of approved proxies can all be contacted (e.g., via email, etc.) with a message that they can have the opportunity to earn a payment if they help complete this transaction (and the first one to respond in the affirmative can be used as the proxy).

An actual example of the method will now be described. Joe (the sender) wants to send $1,000 to his friend Fred (the receiver) instantly. Since Joe and Fred have accounts at different banks (Joe has an account at Ace Bank and Fred has an account at Zoro Bank), if Joe requests his bank to make the transfer it may take a few days. So Joe logs onto a web site administered by an intermediary. Joe registers and provides his name, social security number, banking information (including routing and checking numbers, etc.), a usemame/password, and any other information the intermediary may need for Joe to register an account. Joe then requests in the web site to transfer $1,000 to Fred and provides Fred’s banking information (e.g., Fred’s bank name, routing number, checking account number and/or account number, etc.) and other information (e.g., email, etc.) The web site would then inform Joe that he would have to pay $1,100 in order to make a quick transfer (the extra $100 representing a commission). Joe accepts the $1,100 charge and Joe requests that his bank transfer $1,100 to the intermediary’s bank account (there may be a banking fee for the transfer that Joe would also have to pay). Alternatively, Joe can use his credit card to pay the $1,100 to the intermediary. The intermediary receives a confirmation that Joe has made payment of the $1,100 to the intermediary (whether or not the intermediary actually receives the money immediately is irrelevant).

The intermediary reviews its database of available proxies and identifies Bill as a potential proxy that has an account at Zoro Bank. Bill’s account is reviewed and it is verified that Bill has more than $1,200 ($200 being the minimum balance that Bill requires in his account at Zoro Bank). Thus, Bill is selected as the proxy. The intermediary logs into the Zoro Bank web site as Bill (using Bill’s login information which it received from Bill when Bill registered as a proxy) and automatically transfers $1,000 to Fred. Zoro bank charges a $10 intrabank transfer fee, so $1,010 is actually deducted from Fred’s bank account. Fred (since this is an intrabank transfer) should receive the transfer from Bill quickly (immediately, by the end of the business day, or other brief period of time) along with a communication (e.g., email) that $1,000 has been transferred to Fred’s account which was originated from Joe.

The intermediary transfers the $1,060 to Bill using a bank transfer from the intermediary’s bank account to bill’s bank account (or other payment mechanism such as PAYPAL, check, etc.) The $1,060 represents the $1,000 that was transferred to Fred plus the $10 banking fee that Bill paid for the intrabank transfer (from Bill to Fred) plus $50 representing a payment to Bill for serving as the proxy. The intermediary may also have to pay a banking fee (e.g., $5) for the transfer to Bill’s account.

The intermediary’s bank account will eventually receive the $1,100 that Joe transferred to the intermediary’s bank account (as payment to the intermediary for the privilege of the quick transfer of $1,000 to Fred). Since the intermediary paid $1,060 to Bill and a $5 banking fee for the transfer to Bill, the intermediary’s profit is $35 ($1,100 received minus $1,060 paid to Bill minus $5 banking fee). The profit of $35 is the intermediary’s reward for organizing and initiating the entire set of transactions.

In an alternative embodiment, the proxy Bill would not be a person but would be an account that is owned by the intermediary at Zoro bank (the intermediary can operate proxies at numerous different banks). In this embodiment, the transfer from the proxy account to the receiver (Fred) would be performed immediately and automatically by the intermediary. In addition, no payment to the proxy would be necessary since the intermediary would own all of the proxies.

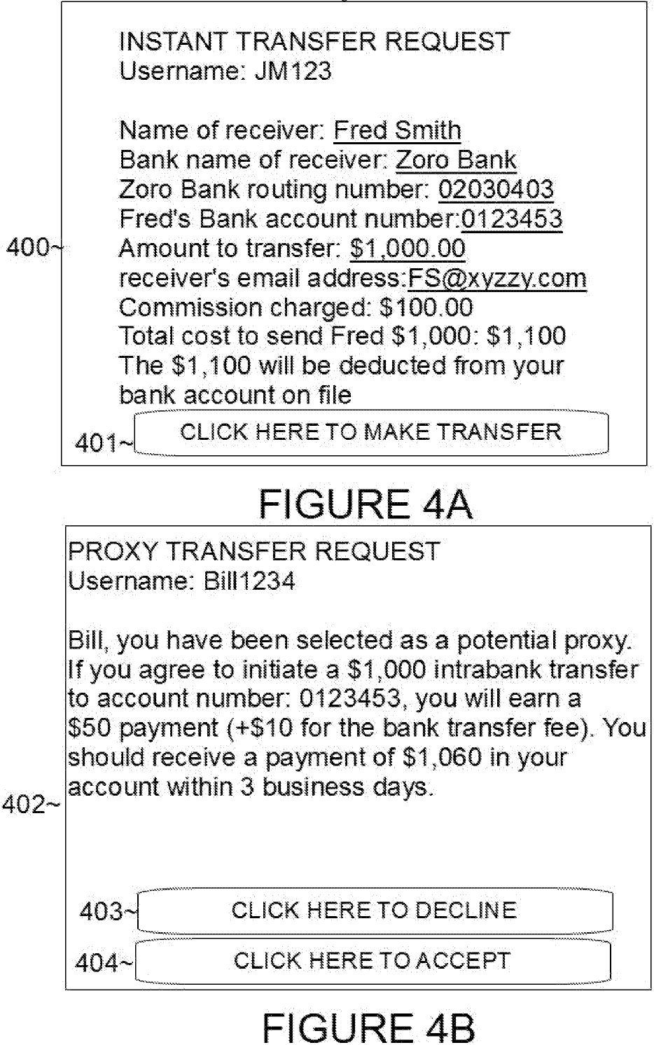

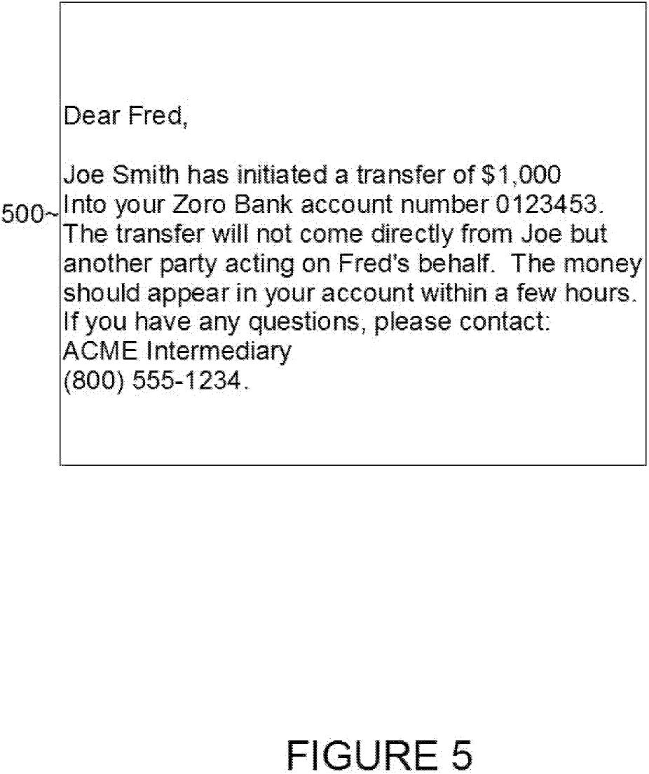

FIG. 4A is a drawing illustrating an example transfer request window, according to an embodiment.

A sender can sign onto the intermediary’s web site and make a request for an instant transfer (which will invoke the method described herein). It is assumed that the sender has already registered with the intermediary and provided his/her name, banking information, email address, and all other needed information.

An instant transfer request 400 window prompts the sender for information regarding the sender’s request (the information the sender types is underlined). The sender would provide the recipient’s name, banking information, email address, and any other relevant information the intermediary may need for its records. The sender can be presented with the commission amount (in this case $100) which is the surcharge the sender would have to pay for the privilege of using the expedited transfer process. The sender can initiate the process by clicking a send button 401 which would automatically initiate the process, including deducting the $1,100 from the sender’s bank account (which was provided to the intermediary by the sender when the sender registered). The receiver would typically also be emailed alerting the receiver to be on the lookout for $1,000 in funds that will be transferred into the receiver’s account shortly.

FIG. 4B is a drawing illustrating an example proxy transfer request window, according to an embodiment.

A proxy transfer request window 402 can be presented to a potential proxy to ask their permission to participate in the transaction. The potential proxy can receive an email invitation (from the intermediary) with a link which when clicked would bring up the proxy transfer request window 402 (which is administered by the intermediary).

The proxy transfer request window 402 displays the duties of the potential proxy (how much money to transfer and into which account) and how much the potential proxy would make if the potential proxy accepts. If the potential proxy does not accept, the potential proxy can click a decline button 403, and the declination is transmitted to the intermediary who then may try to find another potential proxy to accept. If a suitable proxy cannot be found, then the intermediary may have to email the sender with the news that the transfer cannot be effectuated and if the sender has already transferred any money to the intermediary this transfer will be canceled (or the money transferred back to the sender).

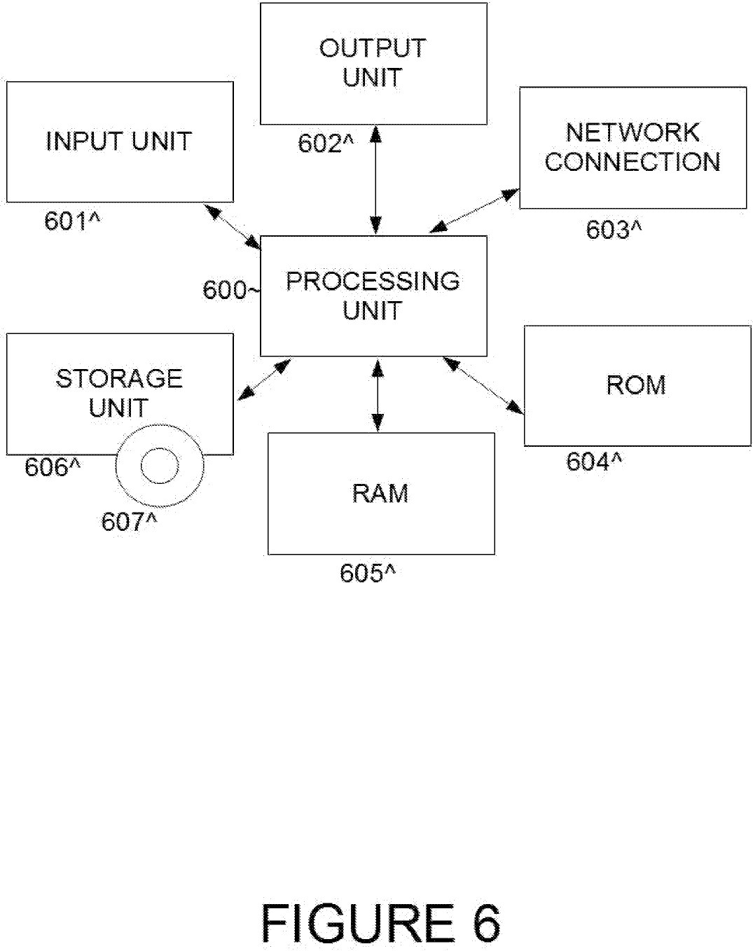

If the potential proxy accepts, then the potential proxy can click an accept button 404 which transmits the acceptance to the intermediary who then can initiate further transfers in accordance with the method, e.g., operations 203,204 and 202 (if not carried out already). FIG. 5 is a drawing illustrating a communication sent to a receiver indicating the transfer of funds to the receiver, according to an embodiment.

An email (or other mechanism of communication) 500 can be sent by the intermediary to the receiver alerting them to the upcoming transfer into Fred’s account. It is important for Fred to be alert that the transfer may come from an account he may not recognize (the proxy’s account) so that Fred is not alarmed or puzzled as to the origination of the funds.

FIG. 6 is a block diagram illustrating components needed to implement a digital computer that can be used to implement the methods described herein, according to an embodiment. The computer can be for example, a server, a database, personal computer, cellular phone, tablet, any portable computing device, etc., which can serve as any party described herein (a bank, intermediary, etc.)

A processing unit (such as a microprocessor and associated structure e.g., bus, cache, etc.) is connected to an input unit 601 (e.g., keyboard, mouse, touch-screen display, etc.) and an output unit 602 (e.g., LCD display, touch-screen display, speaker, etc.) and a network connection 603 which allows the processing unit 600 to communication to/from a computer communications network such as the Internet. The processing unit 600 can also be connected to a ROM 604, RAM 605, and a storage unit 606 (e.g., hard disk drive, BLU-RAY drive, CD-ROM drive, etc.) which can read a computer readable storage medium 607 (e.g., disk, BLU-RAY disc, CD-ROM, EPROM, etc.). The computer readable storage medium 607, RAM 605, and/or ROM 604 can all store instructions (and other assets) which can implement any of the methods described herein.

Software to perform all methods described herein can be programmed, stored on a computer readable storage medium, and executed on an electronic processor. Electronic processors that perform the methods described herein can be run on the server side, client side, or any computer in the system appropriate for its respective function. When different parties/servers perform different functions, then each server is individually programmed to execute its respective functions on its processing unit. Computers/servers are known in the art and can comprise a one or more processors attached to an input device (e.g., keyboard), output device (e.g., LCD display), ROM, RAM, computer readable storage device, network connection (to communicate with the Internet and any other component it needs to communicate with), and any other component needed to implement a computer, server, or any other component that is part of the system

All features of documents that are incorporated by reference can be combined without limitation with each other and with features described in the text fully set forth herein. Features described herein can be combined with any feature(s) in the documents incorporated by reference without limitation.

It is noted that the order of any of the operations described herein can be performed in any order. Any operation described herein can also be optional. All flowcharts herein are not intended to illustrate the only possible implementation, and modifications and deviations can be added which include any feature described herein or based on well-established principles. For example, while endless loops may be theoretically possible in some flowcharts, in reality such situations could be handled using common sense approaches. Any embodiments herein can also be stored in electronic form and programs and/or data for such can be stored on any type of computer readable storage medium (e.g. CD-ROM, DVD, disk, etc.)

The descriptions provided herein also include any hardware and/or software known in the art and needed to implement the operations described herein. All components illustrated herein may also optionally communicate with any other component (either illustrated/described herein or not described but known in the art).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
registering, by a proxy device, with an intermediary device, wherein the registering comprises sharing login credentials with an account associated with the proxy device at a website hosted by a device of a second institution and an agreement to conduct a transaction related to the account associated with the proxy device, wherein the proxy device, the intermediary device and the device of the second institution are communicatively coupled via a communications network;
allowing, by the proxy device, the intermediary device to log in to the account associated with the proxy device via the website and verifying an account balance of the account associated with the proxy device at the second institution;
authorizing, by the proxy device, an execution of an electronic intrabank wire transfer of the amount of funds from the account associated with the proxy device at the second institution to an account associated with a receiver device at the second institution, wherein the receiver device is communicatively coupled to the device of the first institution, the proxy device, the intermediary device and the device of the second institution via the communications network; and
receiving, by the proxy device, a confirmation of an electronic interbank wire transfer of the amount of funds and a payment from an account associated with the intermediary device at a third institution to the account associated with the proxy device at the second financial institution, wherein the electronic intrabank wire transfer from the account associated with the proxy device at the second institution to the account associated with the receiver device at the second institution occurs prior to the electronic interbank wire transfer of the amount of funds and the payment from the account associated with the intermediary device at the third institution to the account associated with the proxy device at the second financial institution.

2. The method of claim 1, wherein the allowing comprises signing an agreement on the website by the proxy device.

3. The method of claim 1, wherein the authorizing comprises receiving, by the proxy device, a request to act as a proxy via a request window and authorizing the request via the request window.

4. The method of claim 1, wherein the authorizing comprises logging in to the website hosted by the device of the second institution by the proxy advice and initiating the electronic interbank wire transfer and the electronic intrabank wire transfer via the website.

5. The method of claim 1, wherein the receiving comprises displaying, by the proxy device, an option to accept the request and an option to decline the request via a request window.

6. The method of claim 1, comprising choosing a proxy associated with the proxy device by the intermediary via a crowd-sourcing procedure based on characteristics of the account associated with the proxy device.

7. The method of claim 1, wherein the electronic interbank wire transfer comprises one or more of:
a different amount of funds than the electronic intrabank wire transfer; and
reimbursement for the electronic intrabank wire transfer.

8. A proxy device, comprising:
a memory; and
a processor configured to:
register with an intermediary device, wherein the register comprises a share of login credentials with an account associated with the proxy device at a website hosted by a device of a second institution and an agreement to conduct a transaction related to the account associated with the proxy device, wherein the proxy device, the intermediary device and the device of the second institution are communicatively coupled via a communications network;
allow the intermediary device to log in to the account associated with the proxy device via the website and verify an account balance of the account associated with the proxy device at the second institution;
authorize an execution of an electronic intrabank wire transfer of the amount of funds from the account associated with the proxy device at the second institution to an account associated with a receiver device at the second institution, wherein the receiver device is communicatively coupled to the device of the first institution, the proxy device, the intermediary device and the device of the second institution via the communications network; and
receive a confirmation of an electronic interbank wire transfer of the amount of funds and a payment from an account associated with the intermediary device at a third institution to the account associated with the proxy device at the second financial institution, wherein the electronic intrabank wire transfer from the account associated with the proxy device at the second institution to the account associated with the receiver device at the second institution occurs prior to the electronic interbank wire transfer of the amount of funds and the payment from the account associated with the intermediary device at the third institution to the account associated with the proxy device at the second financial institution.

9. The proxy device of claim 8, wherein the processor is configured to receive a signed agreement on the website.

10. The proxy device of claim 8, wherein the processor is configured to receive a request to act as a proxy via a request window and authorize the request via the request window.

11. The proxy device of claim 8, wherein the processor is configured to log in to the website hosted by the device of the second institution by the proxy advice and initiate the electronic interbank wire transfer and the electronic intrabank wire transfer via the website.

12. The proxy device of claim 8, wherein the processor is configured to display an option to accept the request and an option to decline the request via a request window.

13. The proxy device of claim 8, wherein the processor is configured to choose a proxy associated with the proxy device by the intermediary via a crowd-sourcing procedure based on characteristics of the account associated with the proxy device.

14. The proxy device of claim 8, wherein the electronic interbank wire transfer comprises one or more of:
a different amount of funds than the electronic intrabank wire transfer; and
reimbursement for the electronic intrabank wire transfer.

15. A non-transitory computer-readable medium comprising instructions, that when read by at least one processor, cause the at least one processor to perform:
registering, by a proxy device, with an intermediary device, wherein the registering comprises sharing login credentials with an account associated with the proxy device at a website hosted by a device of a second institution and an agreement to conduct a transaction related to the account associated with the proxy device, wherein the proxy device, the intermediary device and the device of the second institution are communicatively coupled via a communications network;
allowing, by the proxy device, the intermediary device to log in to the account associated with the proxy device via the website and verifying an account balance of the account associated with the proxy device at the second institution;
authorizing, by the proxy device, an execution of an electronic intrabank wire transfer of the amount of funds from the account associated with the proxy device at the second institution to an account associated with a receiver device at the second institution, wherein the receiver device is communicatively coupled to the device of the first institution, the proxy device, the intermediary device and the device of the second institution via the communications network; and
receiving, by the proxy device, a confirmation of an electronic interbank wire transfer of the amount of funds and a payment from an account associated with the intermediary device at a third institution to the account associated with the proxy device at the second financial institution, wherein the electronic intrabank wire transfer from the account associated with the proxy device at the second institution to the account associated with the receiver device at the second institution occurs prior to the electronic interbank wire transfer of the amount of funds and the payment from the account associated with the intermediary device at the third institution to the account associated with the proxy device at the second financial institution.

16. The non-transitory computer-readable medium of claim 15, wherein the allowing comprises signing an agreement on the website by the proxy device.

17. The non-transitory computer-readable medium of claim 15, wherein the authorizing comprises receiving, by the proxy device, a request to act as a proxy via a request window and authorizing the request via the request window.

18. The non-transitory computer-readable medium of claim 15, wherein the authorizing comprises logging in to the website hosted by the device of the second institution by the proxy advice and initiating the electronic interbank wire transfer and the electronic intrabank wire transfer via the website.

19. The non-transitory computer-readable medium of claim 15, wherein the receiving comprises displaying, by the proxy device, an option to accept the request and an option to decline the request via a request window.

20. The non-transitory computer-readable medium of claim 15, wherein the instructions, when read by the at least one processor, cause the at least one processor to perform choosing a proxy associated with the proxy device by the intermediary via a crowd-sourcing procedure based on characteristics of the account associated with the proxy device.
